(19) United States
(12) Patent Application Publication
(10) Pub. No.: US 2014/0283115 A1
(43) Pub. Date: Sep. 18, 2014

(54) METHOD AND SYSTEM FOR MONITORING ACCESS ATTEMPTS OF SHARED MEMORY OF DATABASES

(71) Applicant: INTERNATIONAL BUSINESS MACHINES CORPORATION, Armonk, NY (US)

(72) Inventors: Ron Ben-Natan, Lexington, MA (US); Leonid Rodniansky, Allston, MA (US)

(73) Assignee: INTERNATIONAL BUSINESS MACHINES CORPORATION, Armonk, NY (US)

(21) Appl. No.: 13/840,038

(22) Filed: Mar. 15, 2013

(51) Int. Cl. G06F 21/60

(52) U.S. Cl. CPC G06F 21/60
USPC 726/27

(57) ABSTRACT

An approach for auditing database access attempts within a computer system. In one implementation, the computer system provides a target server for directing client requests for database access to the target server. In another implementation, the computer system provides a plurality of filtering agents which intercept the client requests and each filtering agent forwards a respective set of client requests which match a respective filter profile to a processing entity.

### FIELD OF THE INVENTION

The present invention relates generally to database system access monitoring, and more particularly to interception of database access attempts in shared memory of a database server, and transmittal of the intercepted database access attempts to data receiving server.

### BACKGROUND

Organizations, including public or private entities, often protect sensitive information, including database resources of database servers of the organizations by utilizing security mechanisms or data security techniques to monitor access attempts to access the database resources, such as, database repository or storage of the database servers.

For example, the process of communicating with a network begins with an access attempt, in which one or more users interact with a communications system to enable initiation of user information transfer. An access attempt itself begins with an issuance of an access request by an access originator. Also, an access attempt ends either in successful access or in access failure. In addition, an unsuccessful access can result in termination of the attempt in any manner other than initiation of user information transfer between the intended source and destination (sink) within the specified maximum access time.

Moreover, the protected security mechanisms of the database servers monitors the access attempts of the protected database resources by intercepting and analyzing database traffic between local database clients and the database servers over a network. The local database clients often select efficient shared memory connections to access the database servers. Also, the shared memory connections utilize shared memory of the database server as an intermediate storage for storing data transmitted between the local database clients and the database servers. The transmitted data typically includes requests to access the database servers. Also, shared memory database sessions of the stored data are audited by intercepting agents of the database servers. The intercepting agent transmits the stored data for further analyzes and logging to an external database server security mechanism.

### SUMMARY

The present invention includes a method, system and computer program product for monitoring database access attempts within a computer system. The method includes auditing database access attempts in shared memory of a database server within the computer system, and transmittal of the audited database attempts to a receiving server which does not process the database attempts for security verification. In particular, the computer system provides a target server for directing client requests for database access to the target server. The computer system also provides a plurality of filtering agents which intercept the client requests and each filtering agent forwards a respective set of client requests which match a respective filter profile to a processing entity.

### BRIEF DESCRIPTION OF THE SEVERAL VIEWS OF THE DRAWINGS

Novel characteristics of the invention are set forth in the appended claims. The invention itself, however, as well as preferred mode of use, further objectives, and advantages thereof, will be best understood by reference to the following detailed description of the invention when read in conjunction with the accompanying Figures, wherein like reference numerals indicate like components, and:

FIG. 1 is a functional block diagram of a data processing environment for intercepting database access attempts by a local intercepting agent in shared memory of a database server in accordance with embodiments of the present invention.

FIG. 2 is a functional block diagram of an alternative embodiment of data processing environment in accordance with embodiments of the present invention.

FIG. 3 is a functional block diagram of a processing environment in which one or more multiple local intercepting agents transmit database access attempts directly to external database server security mechanisms for verification in accordance with embodiments of the present invention.

FIG. 4 is a functional block diagram of a processing environment in which multiple local intercepting agents transmit database access attempts directly to a load balancer which transmits the database access attempts to an external database server security mechanism for verification in accordance with embodiments of the present invention.

FIG. 5 is a flowchart depicting steps performed by a server program in accordance with embodiments of the present invention.

FIG. 6 illustrates a block diagram of components of computer system in accordance with embodiments of the present invention.

### DETAILED DESCRIPTION

Embodiments of the present invention will now be described in detail with reference to the accompanying drawings. Referring to FIG. 1, data processing environment 100 for intercepting database access attempts by a local intercepting agent (LIA) in database shared memory of a database server, wherein an external database server security mechanism (EDSM) is not designated to receive the intercepted access attempts of LIA. LIA transmits the intercepted database access attempts or shared memory database sessions (SMDS) to data receiving server (DRS), which receives the SMDS 104 without further processing. EDSM intercepts the transmitted SMDS 104 and analyzes it for security verification. DRS is reliable as a single point of failure, described in more details below, in accordance with the present invention.

Data processing environment 100 includes database server 101, data receiving server (DRS) 106 and external server security database mechanism EDSMs (110, 111). In addition, database server 101 comprises local intercepting agent (LIA) 103, database shared memory 102 and server program 112.

According to at least one embodiment, LIA 103 intercepts shared memory database sessions (SMDS) 104 from database shared memory 102 and transmits the intercepted database access SMDS 104 to DRS 106 via network 105. DRS 106 is designated to only receive the intercepted SMDS 104, and does not process SMDS 104. DRS 106 is a host data sink that is only responsible to receive TCP/IP packets of the intercepted SMDS 104. EDSMs (110, 111) are not directly connected to LIA 103 or DRS 106, and thus, not receiving SMDS 104. LIA 103 does not directly transmit SMDS 104 to EDSMs (110, 111), and therefore, EDSMs (110, 111) shouldn't expect to receive SMDS 104 from LIA 103. EDSMs (110, 111) intercepts data (108, 109) or database traffic of the transmitted SMDS 104 to DRS 106, over network 105, for auditing and security analysis of SMDS 104 database server 101, according to external server security database mechanism receiving rules, as described below.

In one example, a network based intrusion, including, for example LIA 103 of database server 101, identifies SMDS 104 of database server 101, wherein SMDS 104 is directed to server program 112 of a protected database resource of database server 101. LIA 103 is a lightweight local agent operable to intercept SMDS 104. Sever program 112 identifies SMDS 104. In one embodiment, LIA 103 intercepts the identified SMDS 104, and transmits the intercepted SMDS 104 to DRS 106. Identification of SMDS 104 includes, for example, listening, at a common access point of database server 101, for an incoming connection to database server 101. For instance, a user initiates a connection attempt a local client network through a telnet request, for example, or other transport mechanism on database server 101.

Furthermore, LIA 103 monitors database communications, local or remote communications of database server 101, and relies on EDSMs (110, 111) to perform security systems analyses of client request of database server 101. EDSMs (110, 111) intercepts data (108, 109) or database traffic of the transmitted SMDS 104, through an interception mechanism, and performs monitoring, analyzing, logging of SMDS 104.

LIA 103 identifies a plurality of security access paths to a protected client database resource of database server 101, in which SMDS 104 occurs exclusively via the identified security access paths. The interception mechanism of EDSMs (110, 111) is part of an implementation of IBM InfoSphere® Guardium® STAP® (IBM, InfoSphere, Guardium, and S-TAP are trademarks of International Business Machines, in the United States, other countries, or both). IBM InfoSphere® Guardium® includes an interception engine. The interception engine is part of EDSMs (110, 111) that is responsible for monitoring and intercepting database traffic of SMDS 104. DRS 106 does not analyze and does not transfer SMDS 104 transmitted to DRS 106 from LIA 103. In addition, DRS 106 is also implemented as a redundant grid of data receiving servers.

EDSMs (110, 111) monitors database traffic based on information or data extracted from the transmitted SMDS 104 over network 105. Network 105 includes TCP/IP network packages of the network ports of data processing environment 100. For example, EDSMs (110, 111) extracts information of the TCP/IP packages, and transmits the extracted information to parser modules (120, 121) of EDSMs (110, 111). Parser modules (120, 121) analyze the transmitted data packages of LIA 103 and DRS 106 for security validation purpose of database server 101. In particular, parser modules (120, 121) analyzes database traffic of network 105 based on SMDS 104 transmitted by LIA 103, and extracts information of the database traffic according to iptables rules defined in EDSMs (110, 111). Parser modules (120, 121) are processing entity of EDSMs (110, 111), wherein EDSMs (110, 111) is an adapter that operates in promiscuous mode, and monitors SMDS 104 that matches filtering profiles EDSMs (110, 111), and also identifies SMDS 104 that violates security profiles of EDSMs (110, 111).

EDSM transmits the monitored SMDS 104 to parser modules (120, 121). Parser modules (120, 121) process SMDS 104 to confirm if security profiles of the client requests are violated by SMDS 104, and whether the SMDS 104 matches security profiles the client request. For example, if the security profiles are violated by SMDS 104, parser modules (120, 121) issue an alert for database server 101, in accordance with embodiments of the present invention.

FIG. 2 illustrates an alternative embodiment of data processing environment 100 for intercepting SMDS 104 by a multiple local intercepting agents, LIA, 103, 202, 203 in database shared memory 102 of database server 101, in accordance with embodiments of the present invention. LIA, 103, 202, 203, transmits SMDS 104 of FIG. 1 to DRS 106, which receives SMDS 104 without further processing as described above.

EDSMs (110, 111) intercept the transmitted SMDS 104 by multiple LIA, including, LIA 103, 202, 203, over database traffic, including, networks 108, 109, 113. In a similar manner, EDSMs (110, 111) performs monitoring, analyzing, logging, and guard against SMDS 104. Parser modules (120, 121) of FIG. 1, analyze transmitted data packages of SMDS 104 of the multiple LIA 103, 202, 203 and DRS 106 for security validation purposes of database server 101, in accordance with embodiments of the present invention.

FIG. 3 illustrates a processing environment 300 in which one or more local multiple intercepting agents LIA 103, 202, 203, transmit SMDS 104 directly to external database server security mechanism EDSMs (110, 111) for processing and verification.

In the depicted illustration, EDSMs (110, 111) comprises a separate network address, and includes a set of security policies of database server 101. LIA 103, 202, 203 transmits SMDS 104 of database server 101, for example, directly to EDSMs (110, 111) wherein EDSMs (110, 111) processes, monitors, analyzes, or logs SMDS 104 for security verification. In a database storage and retrieval environment, such as, processing environment 300, EDSMs (110, 111) data security techniques enforce selective access to a protected resource such as data storage repository, or database of database server 101 of processing environment 300.

In addition, EDSMs (110, 111) analyze incoming data access attempts, including, for instance, SMDS 104 of database server 101, and determines the propriety of access of SMDS 104. In addition, EDSMs (110, 111) examines security variable of SMDS 104, such as the originator or user of SMDS 104, and data and/or objects sought of SMDS 104. EDSMs (110, 111) analyses security variable of SMDS 104 against an access policy of rules or behavior which defines allowable access attempts of SMDS 104. For instance, such selective access analyzed by EDSMs (110, 111), allows SMDS 104 from authorized sources, and denies unauthorized access attempts of SMDS 104 as intrusions. EDSMs (110, 111) also enforces either a network based or host based approach of SMDS 104.

In one example, a host based approaches monitor operations on a local computer system, or host, performing access to the protected resource, such as a database. In a conventional host based security monitor, however, the security monitor may impose substantial overhead on the primary communications path to the database. Further, EDSMs (110, 111) receives and analyzes each SMDS 104, usually, by logging transactions of SMDS 104 and flagging those deemed as possible intrusions. In contrast, network based intrusion detection mechanisms by EDSMs (110, 111) analyzes SMDS 104 prior to transport into a host computer system, including, for instance, database server 101. Such network based monitor of EDSMs (110, 111), therefore, do not consume CPU or storage resource on the host computer system.

A typical network based monitor of EDSMs (110, 111) may be provided in a standalone computer system on a network connection into the host computer system, or may be integrated with other computing systems such as an intranet gatekeeper or firewall system. Therefore, network based approaches allow monitoring, logging, and analysis of database access attempts without burdening the host computer, and also operate prior to transmission of the alleged intrusion into the host computer.

In addition, data applications of EDSMs (110, 111) have particular need for such intrusion detection of SMDS 104 because such applications control access to a substantial quantity of possibly sensitive data. For instance, in a Structured Query Language (SQL) database environment, for example, EDSMs (110, 111) may have access to table and attributes corresponding to SQL schema, and therefore be operable to apply SQL specific access policy to the incoming access attempts of SMDS 104. Database techniques of EDSMs (110, 111) usually employ a conventional database administrator account or trusted dial-up link to monitor SMDS 104 via EDSMs (110, 111).

FIG. 4 is illustrates a data processing environment 400 in which multiple intercepting agents, LIA 103, 202, 203 transmit database access attempts SMDS 104 directly to load balancer 410, which transmits SMDS 104 to EDSMs (110, 111, 430).

LIA 103, 202, 203 transmits SMDS 104 to load balancer 410, which transmits SMDS 104 to EDSMs (110, 111, 430) for processing. Load balancer 410 introduces a single point of failure for the intercepted SMDS 104 from LIA 103, 202, 203. Load balancer 410 executes processes, such as processing of SMDS 104 to balance an amount of load amongst one or more database servers, including for example, balancing load, including SMDS 104, transmitted by LIA 103, 202, 203 from database server 101.

Furthermore, balancing load of SMDS 104 by load balancer 410 includes, for example, directing or managing system application requests of LIA 103, 202, 203 to transmit SMDS 104, hence, providing a single point of failure for the intercepted SMDS 104. In this manner, load balancer 410 transmits the managed intercepted SMDS 104 to EDSMs (110, 111, 430), which processes, monitors, analyzes, or logs SMDS 104 for verification. For example, load balancer 410 load balances transmission of SMDS 104 from LIA 103, 202, 203 by analyzing current load of the transmitted SMDS 104 and deciding where to place additional load based of SMDS based on the analysis. Load in this instance can also comprise at least the amount of resources allocated to executing the transmitted SMDS 104.

FIG. 5 is a flowchart depicting steps server program 112 of database server 101 of FIG. 1, according to one embodiment of the present invention.

In step 510, server program 112 identifies database client request to access database server 101. In step 520, server program 112 intercepts the database client requests via LIA 103, wherein LIA 103 is a lightweight local intercepting agent of the database server 101 that monitors local or remote access attempts communications, including SMDS 104 of the database server 101. In step 530, server program 112 transmits SMDS 104 to DRS 106 via LIA 103. DRS 106 does not process SMDS 104. DRS 106 is a host data sink that is only responsible to receive TCP/IP packets of the intercepted SMDS 104. In step 540, EDSMs (110, 111) of FIG. 1, intercept the transmitted SMDS 104 that match filtering profiles of the EDSMs (110, 111).

In step 550 SMDS 104 identifies client requests by server program 112 by analyzing database traffic of server program 112 over network 108, 109, and extracting information of the transmitted SMDS 104 based on the analyzed database traffic.

For example, parser modules (120, 121) analyzes the transmitted data packages of LIA 103 and DRS 106 for security validation purpose of database server 101. Specifically, according to the present invention, parser modules (120, 121) analyzes database traffic of network 105 based on SMDS 104 transmitted by LIA 103, and extracts information of the database traffic according to iptables rules defined in EDSMs (110, 111).

FIG. 6 is a functional block diagram of a computer system, in accordance with an embodiment of the present invention.

Computer system 600 is only one example of a suitable computer system and is not intended to suggest any limitation as to the scope of use or functionality of embodiments of the invention described herein. Regardless, computer system 600 is capable of being implemented and/or performing any of the functionality set forth hereinabove. In computer system 600 there is computer 612, which is operational with numerous other general purpose or special purpose computing system environments or configurations. Examples of well-known computing systems, environments, and/or configurations that may be suitable for use with computer 612 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Database server 101 is implemented as an instance of computer 612.

Computer 612 may be described in the general context of computer system executable instructions, such as program modules, being executed by a computer system. Generally, program modules may include routines, programs, objects, components, logic, data structures, and so on that perform particular tasks or implement particular abstract data types. Computer 612 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 6, computer 612 is shown in the form of a general-purpose computing device. The components of computer 612 may include, but are not limited to, one or more processors or processing units 616, memory 628, and bus 618 that couples various system components including memory 628 to processing unit 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 612 typically includes a variety of computer system readable media. Such media may be any available media that is accessible by computer 612, and includes both volatile and non-volatile media, and removable and non-removable media.

Memory 628 includes computer system readable media in the form of volatile memory, such as random access memory (RAM) 630 and/or cache 632. Computer 612 may further include other removable/non-removable, volatile/non-volatile computer system storage media. By way of example only, storage system 634 is provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media is provided. In such instances, each is to be connected to bus 618 by one or more data media interfaces. As will be further depicted and described below, memory 628 may include at least one program product having a set (e.g., at least one) of program modules that are configured to carry out the functions of embodiments of the invention.

Sever program 112 is stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the invention as described herein. Server program 112 is implemented as or are an instance of program 640.

Computer 612 may also communicate with one or more external devices 614 such as a keyboard, a pointing device, etc., as well as display 624; one or more devices that enable a user to interact with computer 612; and/or any devices (e.g., network card, modem, etc.) that enable computer 612 to communicate with one or more other computing devices. Such communication occurs via Input/Output (I/O) interfaces 622. Still yet, computer 612 communicates with one or more networks such as a local area network (LAN), a general wide area network (WAN), and/or a public network (e.g., the Internet) via network adapter 620.

As depicted, network adapter 620 communicates with the other components of computer 612 via bus 618. It should be understood that although not shown, other hardware and/or software components could be used in conjunction with computer 612. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations are implemented by special purpose hardware-based systems that perform the specified functions or acts, or combinations of special purpose hardware and computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In addition, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like, conventional procedural programming languages such as the “C” programming language, a hardware description language such as Verilog, or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Based on the foregoing a method, system and computer program product for intercepting database access attempts by a local intercepting agent (LIA) in shared memory of a database server and directing the intercepted database access attempts to a receiving data server which does not analyze the access attempts has been described. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. Therefore, the present invention has been disclosed by way of example and not limitation.

What is claimed is:

1. A method for monitoring database access attempts within a computer system, the method comprising the steps of:
providing a target server for directing client requests for database access to the target server; and
providing a plurality of filtering agents which intercept the client requests and each filtering agent forwards a respective set of client requests which match a respective filter profile to a processing entity.

2. The method according to claim 1, wherein the filtering agents operates in promiscuous mode to analyze the client requests.

3. The method according to claim 2, wherein an interception engine of the filtering agents analyzes database traffic and extracts information of the client requests based on the analyzed database traffic.

4. The method according to claim 1 further comprising the step of: determining, by a parser module of an interception engine of the filtering agents, database information of the client requests according to a database protocol.

5. The method according to claim 4, wherein the parser module validates the database Information of the client requests of a database server based on database security mechanisms of security profiles of the client requests, and wherein a filtering mechanism of the filtering agents must secure packets of the client requests.

6. The method according to claim 1, wherein if the security profiles are violated, the filtering agents issues an alert for the database server.

7. The method according to claim 1, wherein the intercepting agent is a lightweight local intercepting agent of the database server that is operable to monitor local or remote access attempts communications of the database server.

8. A computer system for au monitoring database access attempts, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to provide a target server for directing client requests for database access to the target server; and
program instructions to provide a plurality of filtering agents which intercept the client requests and each filtering agent forwards a respective set of client requests which match a respective filter profile to a processing entity

9. The computer system according to claim 8, wherein the filtering agents are adapters that operate in promiscuous mode to analyze the client requests.

10. The computer system according to claim 9, wherein an interception engine of the filtering agents analyzes database traffic and extracts information of the client requests based on the analyzed database traffic.

11. The computer system according to claim 8, further comprising: program instructions to determine, by a parser module of an interception engine of the filtering agents, database information of the client requests according to a database protocol.

12. The computer system according to claim 12, wherein the parser module validates the database information of the client requests of a database server based on database security mechanisms of security profiles of the client requests.

13. The computer system according to claim 8, wherein if the security profiles are violated, the filtering agents issues an alert for the database server.

14. A program product for monitoring database access attempts, the program product comprising:
one or more computer-readable tangible storage devices and program instructions stored on at least one of the one or more storage devices, the program instructions comprising:
program instructions to provide a target server for directing client requests for database access to the target server; and
program instructions to provide a plurality of filtering agents which intercept the client requests and each filtering agent forwards a respective set of client requests which match a respective filter profile to a processing entity

15. The program product according to claim 14, wherein the filtering agents are adapters that operate in promiscuous mode to analyze the client requests.

16. The program product according to claim 15, wherein an interception engine of the filtering agents analyzes database traffic and extracts information of the client requests based on the analyzed database traffic.

17. The program product according to claim 14, further comprising: program instructions to determine, by a parser module of an interception engine of the filtering agents, database information of the client requests according to a database protocol.

18. The program product according to claim 17, wherein the parser module validates the database information of the client requests of a database server based on database security mechanisms of security profiles of the client requests.

19. The program product according to claim 14, wherein if the security profiles are violated, the filtering agents issues an alert for the database server.

20. The program product according to claim 14, wherein the intercepting agent is a lightweight local intercepting agent of the database server that is operable to monitor local or remote access attempts communications of the database server.
